(19) United States
(12) Patent Application Publication
(10) Pub. No.: US 2009/0178003 A1
(43) Pub. Date: Jul. 9, 2009

(54) Method for internet distribution of music and other streaming content

(75) Inventor: Mark Geoffrey Fiedler, New York, NY (US)

Correspondence Address: Mark Fiedler, 160 Bleecker Street, #6JE, New York, NY, 10012, US

(73) Assignee: Recent Memory Incorporated

(21) Appl. No.: 12/381,401

(22) Filed: Mar. 11, 2009

Related U.S. Application Data
(63) Continuation-in-part of application No. 11/365,072, filed on Feb. 28, 2006.
Application No. 11/365,072 is a continuation-in-part of application No. 10/956,922, filed on Sep. 30, 2004, now abandoned.
Application No. 10/956,922 is a continuation-in-part of application No. 10/632,775, filed on Aug. 1, 2003, now abandoned.
Application No. 10/632,775 is a division of application No. 09/884,532, filed on Jun. 20, 2001, now Pat. No. 6,804,638.

(51) Int. Cl. G06F 15/16; G06F 3/048; G06Q 30/00; G06Q 50/00; G06Q 20/00

(52) U.S. Cl. 715/810; 709/231; 705/26; 705/40; 705/80

(57) ABSTRACT

A method of promoting and distributing music and similar streaming content on the Internet or a similar network, comprising presentation of streaming content by its originators to potential network broadcasters (webcasters and podcasters), such content provided in a format to securely identify its originators and broadcasters; assembly and broadcasting (webcasting, podcasting) of playlists of such presented content by broadcasters; downloading of selections from broadcast playlists by listeners; and collection and distribution of fees from such downloads, all using software made available for download from the network.

This is a continuation in part of U.S. patent application Ser. No. 11/365,072, filed Feb. 28, 2006, entitled “Method for Internet Distribution of Music and other Streaming Media,” (amended to “Method for Internet Distribution of Music and other Streaming Content”), which is in turn a continuation in part of U.S. patent application Ser. No. 10/956,922, filed Sep. 30, 2004, entitled “Method for Internet Distribution of Music and other Streaming Media,” which is in turn a continuation in part of U.S. patent application Ser. No. 10/632,775, filed Aug. 1, 2003, entitled “Device and Method for Selective Recall and Preservation of Events Prior to Decision to Record the Events,” which is in turn a division of U.S. patent application Ser. No. 09/884,532, filed Jun. 20, 2001, also entitled “Device and Method for Selective Recall and Preservation of Events Prior to Decision to Record the Events,” which is the non-provisional counterpart of U.S. Provisional Patent Application Ser. No. 60/133,801 (Applications and Improvements for Selective Recording Method), filed May 11, 1999.

### FIELD OF THE INVENTION

This invention relates to the promotion, transmission and distribution of streaming content to a population of potential customers over a network, and particularly to the promotion, transmission and distribution of music over the Internet.

### BACKGROUND OF THE INVENTION

The Internet is a comparatively novel context for the distribution of music. Until quite recently, the bulk of all sales (as distinct from free distributions) of recorded music to consumers have been made by record stores (both online and off), who are in turn supplied by a mature, relatively closed production and distribution industry comprising a handful of large record companies (known popularly as “labels”) and numerous smaller “independent labels.” Barriers to entry into this industry have been as high for recording artists as they have been for new production and distribution companies. To have their work distributed with any promise of remuneration, artists have had to negotiate (in common parlance, “sign”) a recording contract with one of these companies, an arrangement offered to only a comparatively small number of artists. Moreover, such contracts are generally not favorable to recording artists: not only do they usually transfer the artist's copyright and control of the music to the label; they also generally provide for payment of royalties to the artist only after deducting a variety of expenses, all incurred at the label's discretion, which comprise virtually all costs of promotion, production and distribution.

The Internet has dramatically expanded the possibilities for recording artists to reach the public, by both lowering the cost of entry and expanding the number of channels available.

In the past several years there has been a veritable explosion of music on the Internet. The vast majority of this music is made available to the public through two distinct kinds of Internet entities: (1) Internet radio stations (“webcasters”), which broadcast a continuous stream of content which a user may “tune into” (without giving users the ability to download content into files) and (2) music sites that list discrete files of content that listeners may sample, play and/or download at their will.

A number of both kinds of sites charge for their services, on a subscription or a per-download basis. Of these, only those that list music titles for downloading at a price can be of any direct monetary benefit to recording artists. This arrangement works best for distributing the music of “signed” artists who possess the advantage of being known to a sufficient audience. Lesser-known artists are at a significant disadvantage in this arena because, to put it simply, people download what they know. Aside from rare and random combinations of chance and human curiosity, a person browsing the Internet generally finds him- or herself at a music website as a result of having been directed there. If it is a band's website, this is usually a result of the band's level of promotion. If it is a music website that lists many selections for download, a potential customer has to believe that a selection is worth the time and effort of downloading. This too is generally the result of promotion-generated awareness, which will be much greater in the case of artists signed with major labels than with unsigned ones.

From the point of view of recording artists and other producers of music wishing to reach the public, websites that broadcast a continuous stream have a decided advantage over those that list titles for playing or downloading: No action is required of a listener to hear any particular content, other than “tuning in” to the broadcast at the right time. Especially with new and unfamiliar content, listeners may not know they want to listen to something until they hear it, and broadcasting a continuous stream of content assures that they will.

However, current continuous-stream audio broadcasting technology does not allow users to download and store segments of music or other content directly from the stream. The major technical obstacle to doing so is this: By the time a listener has heard or viewed enough of a selection to decide to download it, at least some of that selection has already been played; the listener would need to be able to “go back” somehow in order to record the entire selection. Accordingly, there is a need for a means of doing so, which is an object of the present invention.

(As detailed below, the present invention solves this problem by maintaining a buffer on the listener's computer that always contains a certain length of the most recently broadcast material, including all of the selection currently being played. This arrangement also allows listeners to download portions of a broadcast well after the broadcast has ended.)

The ability to download segments from a continuous broadcast stream opens the possibility of enforcing payment for such downloads. The combination of these technologies, using encryption and other security methods, has a clear advantage over the current method of listing files for download.

Some websites that list music titles for downloading include listings of new and unknown music. These are good for those that happen to be displayed near the top of a list, and of much less benefit for those farther down. To overcome this, artists have tried to put attractive searchable keywords in their song titles, but that is of understandably limited utility.

Recording artists (and similar originators of streaming content) need, and it is an object of the present invention to provide them with, access to a large number of potential outlets for their work to be consumed and paid for; and, conversely to provide broadcasters with a large number of sources of content for broadcasts.

### SUMMARY OF THE INVENTION

The present invention comprises a secure system enabling recording artists to distribute their work to Internet broadcasters, with the possibility of having their work broadcast to listeners and receiving payments from those listeners who download their work. Its significance may be understood as follows:

Historically, radio airplay has been the primary means of promoting new music, and streaming audio play on the Internet can clearly serve the same role. It is advantageous for such streaming audio play to be as accessible to the public, free of charge, as radio has historically been. By combining streaming audio with the ability to instantly download segments of it, the new technology may serve not only as an essential promotion vehicle for relatively unknown artists, but also as an optimally placed sales vehicle. Listeners will be able to sample the flavor of a station's “mix” simply by “tuning into” the station. If they like what they hear, they will stay tuned, even while visually browsing other sites. It will cost them nothing, not even a click, to hear the music. And, of course, they will have the ability to download whatever they hear for a modest fee.

In light of the veritable explosion of music made available on the Internet, it has been pointed out that the established record companies (as well as the traditional radio stations that play their music) do perform an essential function: By serving only a small number of artists, they serve to filter the vast quantities of recorded music for certain standards of quality and taste with regard to any particular genre. The present invention brings this ability onto the web in a novel form, employing great numbers of voluntary participants. This phenomenon is expected to emerge as follows: As broadcasters' stations proliferate, each station comes under a certain pressure to distinguish itself with its own unique “flavor” that listeners should come to identify with that station. The “mix” of a station—not just the selection of music, but the particular sequence in which it is presented—is a significant force in attracting and retaining listeners. It is particularly effective in getting them to listen to new music, much more so than merely listing music titles for downloading. (And human-created playlists are clearly superior to those produced, on whatever basis, by computers.) With the present invention, broadcasters will be motivated to assemble playlists—and recording artists will be motivated to place their work with those broadcasters in whom they perceive an affinity—with the expectation of having it heard and collecting fees from listeners' downloads.

This technology works well for music that is relatively unknown—music that listeners will generally be hearing for the first time. The promise of public exposure and possibility of getting paid for downloads will encourage lesser-known artists to place their music with participating broadcasters. Likewise, the promise of a free supply of creative content—along with the possibility of being paid for downloads, in contrast to the certainty of incurring liability for webcast royalties that currently obtains for webcasting music from the established record companies' catalogs—will encourage individuals and organizations to participate as webcasters.

### BRIEF DESCRIPTION OF DRAWINGS

FIG. 1 shows an overall block diagram of the parts of the preferred embodiment and their interrelationships.

FIG. 2 shows interactions between the artist and webcaster modules.

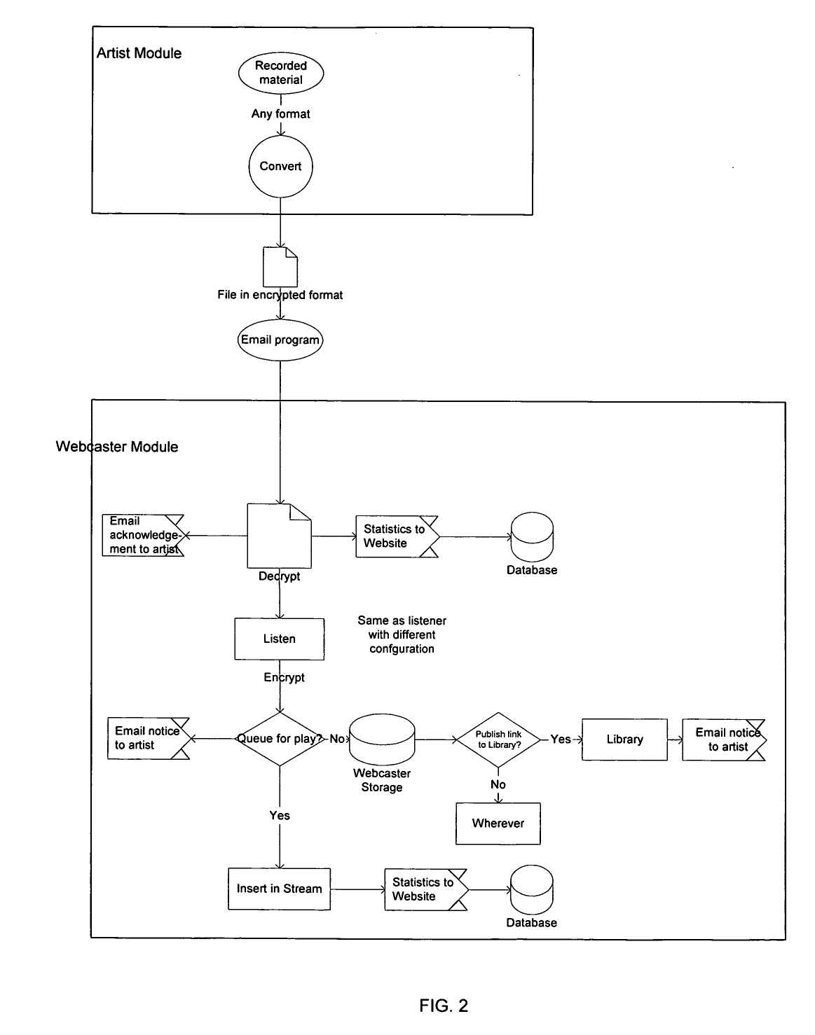

### DETAILED DESCRIPTION OF THE PREFERRED EMBODIMENT

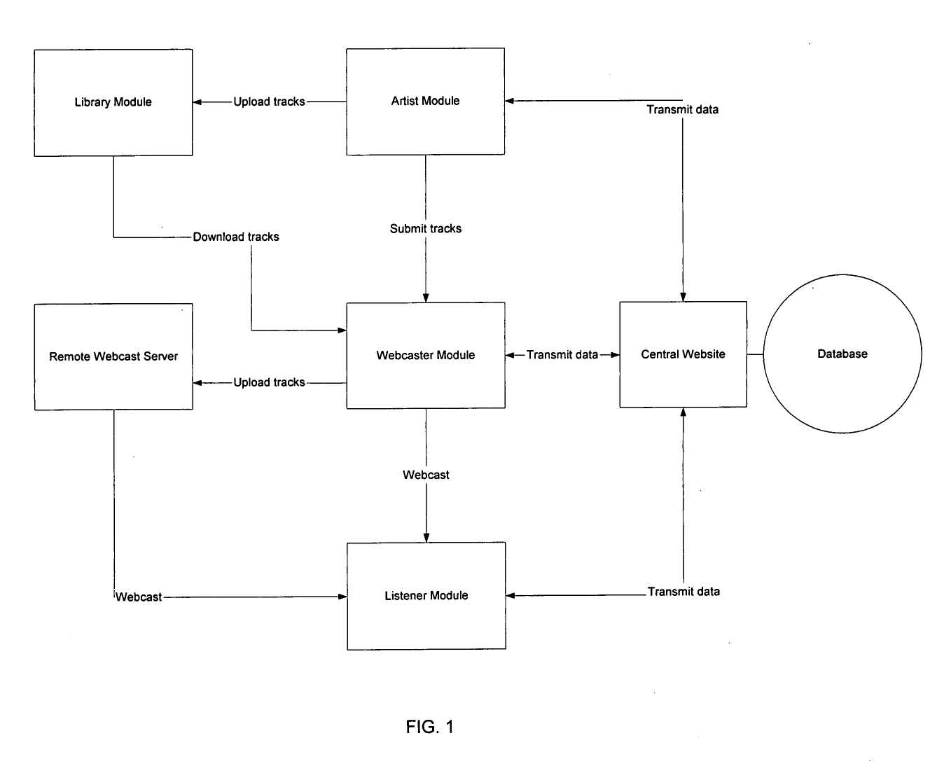

FIG. 1 shows the major components, all advantageously implemented as computer programs (with associated data), and their interrelationships:
(1) An artist module that enables a recording artist (or similar originator of streaming content) to (a) encrypt files of streaming content (“tracks”), tagging them with information identifying the artist, composer, musicians and the like as well as title information, and (b) present them to webcasters, advantageously by transmitting them via electronic mail.
(2) A webcaster module that enables a webcaster to (a) receive and review (i.e., listen to) encrypted streaming files presented by artists, (b) select which of these files to include in webcasts, (c) arrange them into playlists to be webcast, and (d) webcast these playlists.
(3) A listener module that enables a listener to select a webcast, listen to the webcast and select discrete portions of the webcast (generally corresponding to discrete content files) for download. This module advantageously incorporates a circular buffer which accumulates the most recent set of content streamed, advantageously in encrypted form.
(4) An optional library module that enables webcasters to download tracks uploaded by artists for inclusion in webcasts.
(5) An optional remote webcast module that enables webcasters to upload playlists that may be webcast from arbitrary locations on the network.
(6) A central web site comprising a database identifying, at any given time, webcasts currently available for listening (advantageously identifying their associated webcasters as well as their component tracks and their associated artists) and providing, among other things, the ability to search for webcasters and streaming content, advantageously by genre and/or other attributes, such as composer, performer(s), language, and historical or geographical origin. All users—artists, webcasters and listeners—will advantageously use this information to compile lists of tracks artists, webcasters and the like, which are advantageously stored with and retrieved by their respective modules. The central web site also advantageously comprises facilities for registering new artists and webcasters, downloading their respective software modules, providing authentication means for submissions and purchases of streaming content, and managing and distributing the fees paid for downloaded tracks.

The modules and other components described above admit of a variety of implementations. Two or more of these modules may be combined in a single application, or a single module may comprise two or more components, possibly in diverse locations.

These components (and their human users) will interact as follows:
(1) An Internet radio/television station (“webcaster”) will provide a continuous stream of music, video or other content (“webcast”) to listeners. This content stream advantageously will be stored temporarily in a circular buffer (“acquisition buffer”) in the listener's computer or Internet appliance, or otherwise under the control of the listener. The acquisition buffer will accumulate the webcast stream, advantageously in an encrypted format, overwriting the oldest material with current material so that it contains, at any given time, the most recently received material. Listeners (as used herein, the term includes viewers) will be enabled (advantageously for a fee) to permanently save (“download”) portions of the content stream from this acquisition buffer to permanent storage, advantageously in an unencrypted format capable of being played and/or copied freely. This arrangement will be of advantage to webcasters with relatively low bandwidth, as they will be largely freed from the task of re-transmitting the portions of the stream which listeners decide to download—a task that may be precluded at any given time by having all available bandwidth occupied by connected listeners. The listener module will advantageously list all tracks currently contained in the acquisition buffer, enabling listeners to download such tracks even after the webcasts that contained them have ended. Fees paid for downloaded tracks will advantageously be distributed among the associated artists and webcasters as well as the owners of the system.
(2) Recording artists, copyright holders or similar parties (“originators”) will be able to present or submit pieces of their work to webcasters at no charge or at a nominal charge. This presentation is advantageously done over the Internet in a secure form, using the artist module. The presented work advantageously incorporates the originator's bid for a proposed royalty arrangement for the work, which may be encoded using a dedicated software tool. Security in this regard may take a number of forms: In one arrangement, the work may be played by the webcaster but not webcast until enabled by the originator. In another, the originator's proposed royalty arrangement will be securely implemented and enforced when the work is webcast and downloaded, but the webcaster may refuse to webcast the work under those terms. In both of these cases, the webcaster will be enabled to webcast the work in question when both the originator and the webcaster agree on a royalty arrangement. The negotiation software will facilitate the process of coming to such an agreement, and the webcasting software will enforce the agreed terms. The overall fee scheme may incorporate fees (advantageously at a fixed rate, independent of those due webcasters and originators) due to the holder (or a licensee) of this patent, as well those due copyright holders not participating in the system.
(3) Webcasters will typically assemble sequences (“playlists”) of the works of one or more originators, advantageously in an interesting, entertaining or artistic sequence. These playlists will be webcast by each webcaster on one or more channels, using the webcaster module. Each webcaster will advantageously cultivate a reputation or “presence” among the listening public as well as the population of originators, who will be drawn to particular webcasters and their webcast channels on the basis of such reputation. A central Web site will advantageously be maintained by the holder of this patent or a licensee, providing information on the webcasters and the content they provide, advantageously including affinities between webcasters, the genres and/or other attributes of their content, and the like.
(4) The artist, webcaster and listener modules will advantageously be made available for free (or low-cost) download from the central Web site.
(5) It is advantageous to enable originators to place their content tracks (in secure format) in an online storage area (“library”) under their control, accessible on the network, from which such tracks will be made available, by means of a library server module, to webcasters for inclusion in webcast playlists. It may be similarly advantageous to enable webcasters to maintain such libraries as well, for sharing tracks with each other.
(6) It is advantageous to enable webcasters to maintain and launch webcasts from locations other than that of their webcasting modules. To implement this, a remote webcasting server may be provided in a location under a webcaster's control, accessible on the network, to which playlists and their associated track may be uploaded from the webcaster's webcasting module, and from which such playlists may be webcast. Webcasts from remote webcasting servers may be advantageously launched and controlled either from the webcasting module or from a browser (or other suitable application) on the network.
(7) Originators will provide content to webcasters in the form of discrete files or “tracks.” The artist module will maintain lists of tracks (including such pertinent information as title, durations, artists, etc.) that may be presented or submitted to webcasters, and webcaster module will maintain lists for tracks that may be webcast, using well-known or proprietary record-keeping methods and formats. Similarly, lists of webcasters (including information for accessing their webcasts) will be maintained by the artist and listener modules. Such listing information will advantageously be transmitted between the various modules in the system (i.e., the artist webcaster and listener modules, as well as any library modules and remote webcast servers), and will advantageously be included with originators' presentations and/or submissions of tracks to webcasters.
(8) In many cases, a piece of content will advantageously comprise more than one track—for example, a sonata or symphony may consist of several discrete movements to be played in a fixed sequence, and the individual movements may admit of further, similar division. To enable such groupings to be maintained in the distribution of content, it will be of advantage to provide for suites of tracks which may be handled in a similar manner to individual tracks. (Suites may advantageously contain suites (designated subsuites) as well as tracks, possibly nested to an arbitrary depth.) For example, it will be possible to place a suite in a playlist, which would automatically place its component tracks and/or subsuites, in the designated order, into the playlist. Similarly, suites may be presented (or submitted) to or acquired by webcasters in the same manner as tracks.
(9) Webcasters will need to review (i.e., inspect and/or listen to) the tracks of content presented/submitted to or acquired by them, in order to determine whether or where to include them in playlists. To prevent webcasters from “pirating” such content (as by recording the input signal supplied to a sound output device), it will be advantageous to allowing the webcaster to listen to only a limited portion of a track at a time, and to subtly vary the volume (and/or equalization, balance, etc.) between or within reviewed segments, so as to make it difficult to assemble such segments into whole tracks. Similarly, it will be advantageous to degrade the quality of content played by the listener module, for example by adding an appropriate level of white noise, while providing full quality in downloaded tracks.
(10) It is advantageous to generate the following automatic notifications, by electronic mail or message, between the various modules of the system:
   a. to an artist (as well as the central website) upon acceptance of a track by a webcaster;
   b. to the central website upon the initiation of a webcast;
   c. to the artist upon a webcaster's selection of a track for inclusion in a library.
   It is also advantageous to provide artists and webcasters, at their request, with statistics from the database pertaining to the content they have originated and/or webcast.
(11) As some webcasters may receive more submissions than they are willing or able to handle, it is advantageous to enable a webcaster to designate a party (“broker”) to receive submissions from artists. Those selections accepted by the broker will be automatically forwarded to the artists. The webcaster's income from downloads of tracks submitted by a particular broker may be advantageously shared with the broker, advantageously using automated means. The negotiation apparatus described above, or the like, may be advantageously used to arrange such sharing of income.
(12) To augment the number of listeners that may be simultaneously connected to a webcasting server (which may have no more webcasting bandwidth than a low-end personal computer on a home Internet connection), the server may webcast a continuous stream of content to an acquisition buffer on a supplemental server, advantageously with much greater bandwidth, which in turn webcasts the stream to listeners from its acquisition buffer. This second, supplemental server may also webcast to a third server, and so forth. (Any server in the scheme may, of course, advantageously webcast directly to listeners as well to another server.) The scheme may be extended indefinitely, with each successive supplemental server invoked on demand by another server in the sequence. Like webcasting servers, supplemental servers may be operated by arbitrary parties, who may expect payment for their operation. Such payment may be according to a server's operating time and/or an apportioned share of revenue from actual downloads. The negotiation and collection of such payments may advantageously be handled in the same manner as those due originators and webcasters, described below. It is worth noting that a listener's computer or Internet appliance may serve as a supplemental server, re-transmitting the stream of content to other listeners; and that this may entitle such a listener to credits, fees or other similar compensation, which may be derived from the webcaster's fees. Further, a particular finite webcast stream may be initially loaded from an originator's location to a supplemental server and subsequently re-webcast, perhaps repeatedly, by one or more supplemental servers, thus freeing the originator's machine from the task of webcasting the stream in real time.
(13) A listener module, running on a computer or on an appropriate Internet appliance at each listener's location, will advantageously list all selections of music or other content currently contained in the circular buffer (and, advantageously, selections preceding and following these as well). A mark identifying each downloadable selection is advantageously placed in the webcast stream at the beginning of each selection. The location of each such mark contained in the circular buffer is maintained by the listener in association with information identifying and/or describing the selections available to be downloaded. Listeners may decide to download selections that have not yet been transmitted, in which case the listener module will download these when they are transmitted, and on payment of any required fees. Selections lying wholly or partly outside the buffer may be downloaded by specific request to a server. In this connection, it is advantageous to maintain a circular buffer on a server to respond to such requests.
(14) The listener module will enable listeners to listen to webcasts without requiring any payment, by connecting to (or “tuning into”) a station or ordering a finite “mix” or concatenation of works assembled by or for a webcaster. Listeners will pay to download webcast content into files (or similar permanent, possibly reproducible units) on their local workstations or otherwise in their possession or under their control. Originators (and possibly other parties such as webcasters and supplemental server operators) will collect royalties and/or other fees on their work from end users (or intermediate users) of their work from these payments. A number of payment arrangements are possible: In addition to single payments at the time of downloading, subscription arrangements may allow a predetermined number of downloads within a predetermined period of time (with or without the possibility of refunds or rebates for unused opportunities).
(15) Royalties and/or other fees may be shared with webcasters and/or other parties as may be agreed between the parties concerned. Such agreement may be advantageously negotiated via the Internet, using a dedicated software tool or tools. Payments are advantageously collected using well-known “e-commerce” programs, particularly “micropayment” systems. Such programs advantageously incorporate secure storage of credit card data protected by a password for each individual user, as well as means for securing payment to the appropriate parties with regard to each webcaster.
(16) The central website, communicating with the various artist, webcaster and listener applications, enables users to search for both music tracks and webcasters, advantageously on the basis of genre or other attributes (“tags”) such as geographical or historical origin, as well as on character strings in a track's identifying information, such as title, artist name and the like. Each music track will be advantageously tagged with one or more genre and/or other tags
(17) It will be of advantage to assist users at navigating the set of available genre tags, which is expected to evolve over time as new genres emerge and as the relationships among genres become more fully identified. To enable such navigation, it is of advantage to maintain a thesaurus of genre terms, representing the relationships among genres according to well-known principles of computer-based thesauri. These generally involve specifying preferred and non-preferred terms and well as any broader, narrower and related terms for any given preferred term. (Users would be able to navigate the set of terms by proceeding from any particular term to its preferred, broader, narrower and related terms, as applicable.) Applying such principles to genre relationships, such a thesaurus might identify any subgenres (i.e., narrower terms) and/or supergenres (i.e., broader terms) of a particular genre, as well as any genres related to a particular genre, advantageously along with the nature of any such relationships (e.g., influence, derivation). Genres may be represented in this thesaurus as having multiple supergenres as well as multiple subgenres, in keeping with the principles of thesauri.
(18) The thesaurus may advantageously include terms referring to diverse aspects of meaning (or attributes of music or other content), such as language, and/or geographical or historical origin. The aspect of geographical origin may be represented, for example, in a thesaurus by a hierarchy of broader and narrower terms, such as continent, country, and region, with (for example) regions neighboring or overlapping a particular region may be represented as its related terms. Similarly, the thesaurus may represent the aspect of language by reflecting recognized language groups as the broader terms for a particular language (e.g., Germanic for English), its dialects as narrower terms (e.g., Provençal for French), and related languages as its related terms (e.g., Aramaic for Hebrew). Moreover, a term may occur in more than one aspect of meaning—e.g., Latin would occur under genre, language and possibly geographical origin. Accordingly, navigation is advantageously provided from any particular term to its various aspects of meaning.
(19) With regard to searches (both for music and for webcasters), it is of further advantage to include, automatically or optionally, subgenres of a genre included in the search criteria, and optionally its related genres. Attributes such as geographical or historical origin may be similarly represented. In general, it is of similar advantage to include (automatically or optionally) the narrower terms, and/or the related terms, of any term included in search criteria.
(20) The set of available tags, particularly genre tags, may be expected to evolve by way of online discussion groups, organized and operated according to well-known practice. Such groups will advantageously be associated with online libraries maintained by webcasters for sharing among themselves, organized by genre and/or other applicable attributes.
(21) The central website is notified of the initiation of any webcast and supplied the contents of its playlist, which are in turn stored in the database. This enables listeners to search the database for a particular music track (or similar content file) that is currently or soon to be webcast, and to connect to a webcast that contains the track. As in the case of artists searching for webcasters, the results returned from a search for webcasts containing a particular track are advantageously randomized (or pseudo-randomized) over the set of such webcasts.

### Encryption

The various parties involved in these transactions will generally be unknown to each other, and generally not in a position to be trusted by the other parties involved. Accordingly, the identities of parties, particularly artists, webcasters and brokers, are advantageously encoded securely in music track files, advantageously using well-known methods involving encryption, hashes, checksums and the like. Further, steganographic identification of all parties, including listeners, in downloaded music tracks will be of advantage in combating piracy.

To enforce the payment of royalties and other fees to the proper parties, content to be webcast may be advantageously transmitted (in all phases of submission/acquisition and distribution) in encrypted form, which is ultimately decrypted as it is played by the various receiving modules. Acquisition buffers are advantageously used as decryption buffers, in addition to their functions in connection with downloading and ensuring continuous playing of the content stream.

The encryption/decryption scheme may advantageously incorporate the following refinements:
(1) Encryption/decryption keys may be embedded in the transmission data stream at periodic intervals (or at fixed or varying intervals determined by a predetermined scheme); each key will govern the decryption of data following the key and preceding the next key, and provision will be made for a newly connecting user's client application to acquire the current key as well as the location of the next key.
(2) Encryption/decryption keys may be assembled from segments supplied by disparate components of the system involved in a webcast. For example, the key used for encrypting and decrypting the contents of a listener's circular buffer may be assembled from components supplied by the webcaster module, the listener module and/or the central database. Further, these segments may be assembled into the key in a secret, non-straightforward manner.
(3) Sections downloaded by a user may themselves be encrypted, but decryptable by a user supplying a password. Not only does this arrangement limit the free copying of downloaded selections; it also allows the collection of royalties for repeated playings of the selection.
(4) Any such restrictions or fees imposed on copying or playing downloaded selections may be proposed by the originator and/or agreed to by the webcaster and will be indicated to the listener together with any other terms of downloading the selection.

### Non-Participating Content; Anti-Fraud

Current U.S. law mandates the payment of specified royalties for webcasting copyrighted content in the absence of any contractual arrangement between webcasters and copyright holders. Artists participating in the present invention will waive all such webcasting royalties in favor of payment for downloads by listeners, and will certify (by generally accepted mechanized means, as by checking a box on the screen) their valid rights to any music files they present or submit to webcasters. On the other hand, webcasting royalties must be paid on streaming content from non-participating sources, and such content must not be made available for downloading by listeners.

Accordingly, it is necessary to deter and detect fraudulent claims of rights by those presenting or submitting content for webcasting with the ability to download—typically cases of originators passing off other people's work as their own. Towards this end, it is advantageous not only to encrypt the originating artist's identity into all content files presented or submitted by the artist, but to preserve a recoverable, encrypted steganographic record identifying the originating artist identity in all tracks downloaded by listeners. It is also advantageous to encourage all participants—artists, webcasters and listeners—to detect and report cases of fraud, and to establish a forum for adjudicating claims of fraud, with appropriate penalties both for fraud and for intentionally fraudulent claims of fraud.

Webcasting of content from non-participating sources may be advantageously effected as follows: All webcasters (as well as all artists) will have accounts from which funds due them from listeners' downloads will be distributed periodically. The system will advantageously allow the webcasting content from non-participating sources only to the extent that the webcaster's account is credited with sufficient funds to cover the requisite webcast royalties; otherwise the system (i.e., the webcast module) will automatically omit such content from webcasts—advantageously with notice to the webcaster.

### Webcast Buffering

A further advantageous refinement of this general method may be explained as follows:

Consider that a webcast stream typically consists of a series of segments or “tracks,” which typically correspond to musical selections, movements, or pieces; and the prior method enables listeners to purchase individual tracks. When a listener first connects with (or “tunes into”) a specific webcast, it will almost always be in the middle of a track. A listener will typically decide to stay connected (or “tuned”) to a specific webcast on the basis of liking this first, usually fragmentary track, and will likely be inclined to purchase this track. Should the user decide to purchase the track, it will be advantageous (nay, only decent) to provide the listener with the whole track. The method described thus far provides for supplying the listener with the missing portion by a specific request to the server—but this cannot be relied on, particularly if the server is connected to its maximum number of clients (i.e., listeners). Moreover, the fact remains that the listener has not heard the whole first track (more particularly the first part of it), and might have been inclined to purchase it had he or she heard it.

Accordingly, it is advantageous to ensure that the first track a listener hears upon connecting to a webcast will be presented, locally buffered, and offered for purchase in its entirety—or at least from the beginning.

This may be achieved as follows: A webcast server application typically receives input from a single stream of content (in this case, typically music) which is segmented into individual tracks that are demarcated by marks or other indications embedded in or referring to the stream. (Webcast servers may in fact handle multiple input streams, in which case the method described below is applied to each input stream.) The webcast server translates this input stream into multiple Internet-protocol packet streams, one directed to each listener that is connected to the webcast. To ensure that each listener hears the beginning of a track on connecting with the server:
(1) When the webcast server application encounters the beginning of a track, it begins writing a buffer (in memory, on a disk or similar storage device, or in any combination thereof) (a “track buffer”) which will be used to generate the individual packet streams. This buffer grows in size until it contains the entire contents of the track.
(2) As each listener connects with the webcast, the server application begins generating packet streams directed to that listener from the beginning of the track it is currently receiving from a streaming source. Thus each listener hears the current track from the beginning.
(3) A track buffer is maintained until all connected client applications have received its entire contents. At that point it clears, frees, or simply starts overwriting any existing track buffer.
(4) The maximum size of a track buffer may be advantageously set by the server application user. It is also advantageous (alternatively) to check the webcasters hard disk and/or memory capacity for sufficient space for any two successive tracks in the webcast, and (advantageously with notice to the webcaster) to automatically omit from the webcast any track that won't fit.

This method may be similarly applied to any supplemental server as described above.

### Podcasting

As an alternative to connecting to a webcaster's site and receiving a webcast in real time—i.e., listening to or viewing the webcast playlist as it is being transmitted—a listener/viewer may connect to a site, and receive a similar playlist in stored form, e.g., as a download, or as a series of downloads—all in order to be able listen to or view the content at a later time, either on the receiving device or (advantageously) on a portable device. In a development of this practice that has come to be known as “podcasting,” a listener may subscribe to a number of sites (whose content is referred to as “feeds”) and automatically receive any updates to those feeds, which are then automatically transferred from the receiving device (usually a computer) to a portable device each time the two devices are connected and “synchronized.”

The present invention provides a user interface in the listener/viewer user's client application in which, among other things, the user may search for and connect to various webcasts. This user interface may be extended to enable the user to subscribe to and/or cancel subscriptions to podcasting feeds. Further, it is advantageous to offer listeners/viewers the ability to receive the playlist of any particular webcast as a podcast, using well-known methods of podcasting.

The present invention comprises providing a listener free access to webcasts, which are temporarily stored in an area referred to as an “acquisition buffer” on the listener/viewer's receiving device, for the purpose of enabling the listener to decide whether to purchase any selections from that content. All incoming webcasts are saved in the acquisition buffer, advantageously in encrypted form.

In the context of the present invention's application to podcasting, there is a need to limit the listener/viewer's access to newly received content for a limited time (and/or with other limitations) in order to decide whether to purchase any selections from that content.

One way to serve that need—and the one probably least obnoxious to the listener/viewer—is to reserve an acquisition buffer of limited size on the portable device (in addition to the acquisition buffer on the receiving device) for the incoming streams of content. As updates to feeds are received, they will overwrite the oldest material in the acquisition buffer. This will make the storage of content in this acquisition buffer temporary.

The acquisition buffer on the portable device may be advantageously kept in parallel with the acquisition buffer on the receiving device, so that the listener may indicate (or cancel) any decisions to purchase content on either device. This may be achieved by updating the contents of the portable device's acquisition buffer to match the contents of the receiving device's acquisition buffer each time the user synchronizes the two devices. A user interface on the portable device, similar to that of the client application on the receiving device, lists the contents of the acquisition buffer and enables the listener/viewer user to make (and/or cancel) selections for purchase from those contents. When the two devices are synchronized, purchase selections made on the portable device are combined with those made on the receiving device. (In cases of conflicting purchases and cancellations for the same selection, the most recent entries will prevail.)

Assuming that the user has enough credit to make the purchases, the purchased selections are decrypted and copied (as the user may direct) to the portable device and/or the receiving device, where they may be kept indefinitely, and/or copied to other media or locations.

Tracks which have been selected for purchase but have not yet been purchased (“pending tracks”) may be advantageously copied in encrypted form to locations on the receiving device and/or the portable device outside the acquisition buffer: this will ensure that they will not be overwritten by incoming material. Pending tracks are decrypted when they are actually purchased.

It is also of advantage: (1) to enable webcasters to offer their webcast playlists alternatively as podcasts, to enable listener/viewer users to receive the same playlists alternatively as webcasts or podcasts, and (3) to enable those users to establish and cancel subscriptions to podcasting feeds using the user interface on the portable device, in a similar manner to that of the user interface on the receiving device.

Although the transitory, non-transferable storage of content in the acquisition buffer may be adequate to induce users to purchase selections that they desire to keep, there may be some advantage in further limiting the user's free access to that material or interfering with the user's uninterrupted enjoyment of it. A number of methods, which may also be advantageously applied to pending tracks, may be employed to achieve this:
(1) Allowing the user to listen to any particular playlist only once, or a limited number of times.
(2) After a predetermined number of plays or period of time, in any combination:
   a. Refusing to play the contents of a playlist.
   b. Requiring the user to listen to a playlist from the beginning in order to hear any selection in that playlist.
   c. Allowing any particular track to be played only once or a limited number of times per hour, day, week, etc., or requiring a minimum delay between plays.
   d. Playing only a limited portion or portions of any particular track at a time.
   e. Requiring the user periodically to take some action (e.g., clicking the mouse or pressing a button) in order to continue to play contents of a playlist.
   f. Periodically or intermittently interrupting the playing of the contents of a playlist and/or interposing intervals of silence or extraneous sounds.
   g. Overlaying extraneous sounds (continuously, periodically or intermittently) as the content is played.

“Expired” tracks that have exceeded the age or play count in item (2) above may be deleted and/or overwritten with new material.

Although the present invention has been described in connection with particular applications thereof, and the preferred embodiment thereof described in detail, modifications and adaptations may be made thereto, and additional embodiments and applications made thereof, which will be obvious to those skilled in the art, without departing from the spirit and scope of the invention, as delineated in the following claims.

In the following claims, the word “content” (or “streaming content”) refers to digital streaming media, but includes, without limitation, moving pictures, sequences of still pictures, records of music, speech, or any and all auditory or visual events, data or signals, or moving pictures, machine events, states or signals, and the states, signals or sounds of any musical instrument, any of the foregoing being of a discrete or a continuous nature.

I claim:

1. A content distribution method comprising the steps of:
providing conversion means for enabling an originator of streaming content to convert a segment of said content into a secure format incorporating, in a secure manner, information pertaining to said originator in order to provide said segment of content to a broadcaster;
providing presentation means for enabling said originator to make said segment of content in said secure format available to said broadcaster;
providing reviewing means for enabling said broadcaster to review one or more segments of said streaming content, in order to determine whether and where to place said segment(s) in a stream of content to be broadcast,
providing assembly means for enabling said broadcaster to assemble one or more segments of said streaming content into a stream of said content to be streamed to one or more listeners;
providing streaming means that enables said broadcaster to transmit said stream to one or more listeners; and
providing playing means that enables a listener to play said stream of content.

2. The method of claim 1 wherein said conversion means utilizes encryption.

3. The method of claim 1 wherein said presentation means comprises transmitting said secure-format segment of content to said broadcaster.

4. The method of claim 1 wherein said presentation means comprises transmitting a notice identifying said secure-format segment of content to said broadcaster.

5. The method of claim 1 wherein said presentation means comprises placing said secure-format segment of content in a location accessible to said broadcaster.

6. The method of claim 1 wherein said reviewing means comprises one or more of the following:
allowing the webcaster to review only a limited portion of said segment at a time varying the volume (and/or other attributes, such as equalization or balance) between or within reviewed segments

7. The method of claim 1, further providing downloading means that enables said listener to download a portion of said stream by saving said portion to a file.

8. The method of claim 7 wherein said downloading means enables said listener to download a portion of said stream upon payment, or arrangement for payment, of a download fee therefor.

9. The method of claim 1 wherein said playing means degrades the quality of played content relative to downloaded content.

10. The method of claim 8, further providing means for directing said download fees to parties to whom said download fees are due.

11. The method of claim 7 wherein the identity of said originator, broadcaster or listener is represented steganographically in said file.

12. The method of claim 1 wherein said streaming means transmits said stream of content in an encrypted streaming format, which streaming format may be distinct from the secure format in which said broadcaster received said content from the originator of said content.

13. The method of claim 12 wherein said encrypted streaming format utilizes an encryption key embedded in said transmitted stream of content.

14. The method of claim 7 wherein said stream of content transmitted by said streaming software is accumulated in an acquisition buffer from which said listener is enabled to save said download.

15. The method of claim 14 wherein said transmitted stream of content is accumulated in an encrypted format in said acquisition buffer and said listener is enabled to save said download in an unencrypted format.

16. The method of claim 14, further providing display means for displaying information pertaining to any broadcast segments currently contained in said buffer.

17. The method of claim 14 further providing means for listeners to request download of broadcast segments that have not yet been transmitted.

18. The method of claim 14, further providing downloading means for downloading from the broadcast server of a broadcast segment lying wholly or partly outside said buffer.

19. The method of claim 18 wherein said downloading means utilizes a circular buffer on said server.

20. The method of claim 14 wherein said download is saved in an encrypted format.

21. The method of claim 1 wherein one or more of said encryption means, presentation means, assembly means, streaming means, and playback means comprises a computer program.

22. The method of claim 21 wherein one or more of the said conversion means, presentation means, reviewing means, aggregation means, streaming means, or playback means is provided for download from a network to a plurality of potential users.

23. The method of claim 1 wherein said presentation means enables a said originator to propose a proportion of download fees for said content to be paid to said originator, and said proposed proportion of download fees are directed to said originator.

24. The method of claim 1, further providing negotiation means for enabling a said originator and a said broadcaster to negotiate the portions of download fees respectively due said originator and said streamer.

25. The method of claim 1 wherein any of said conversion means, presentation means, reviewing means, assembly means or playing means provides a list representing said segments of said content.

26. The method of claim 25 wherein any item contained in said list comprises a plurality of component segments of said content, to be handled in a predetermined order, so that including any said item in any said list automatically includes its said component segments in said order.

27. The method of claim 24 wherein said streaming means is disabled from transmitting said content to listeners in the absence of an enabling signal from said originator.

28. The method of claim 1, further providing a supplemental server that accumulates in a buffer the said stream of content transmitted by said streaming software, and further transmits said stream of content to a plurality of multicast receivers.

29. The method of claim 28 wherein a said multicast receiver comprises a device that executes said playback software, which playback software in turn plays said stream of content.

30. The method of claim 28 wherein a said multicast receiver comprises a multicast server, which multicasting software further transmits said stream of content to a further said multicast receiver.

31. The method of claim 1, further providing searching means enabling a user to search for broadcasters.

32. The method of claim 31 wherein a search for broadcasters returns a random or pseudorandom subset of broadcasters meeting the criteria of said search.

33. The method of claim 31 wherein said searching means enables a user to search for any broadcasters on the basis of one or more music genres specified by said user.

34. The method of claim 31 wherein said searching means utilizes a database containing information pertaining to said broadcasters.

35. A method of searching for items such as works of music, wherein said items tagged with terms referring to attributes, such as genre, geographical or historical origin; and said terms are represented in a thesaurus indicating any broader, narrower and related terms with respect to any given term.

36. The method of claim 35 wherein a user is enabled to navigate the terms of said thesaurus, proceeding from a particular term to its broader, narrower and related terms, or to its various aspects of meaning.

37. The method of claim 35 wherein a search for items tagged with a particular term automatically or optionally returns items tagged with the narrower terms of said term.

38. The method of claim 35 wherein a search for items tagged with a particular term automatically or optionally returns items tagged with the related terms of said term.

39. The method of claim 31 wherein said searching means enables a user to search for any broadcasters currently broadcasting or scheduled to broadcast a particular segment specified by said user.

40. A broadcast buffering method comprising the steps of:
providing streaming means that enables a broadcaster to transmit a stream of discrete broadcast segments to one or more listeners, which streaming means maintains a track buffer on the transmitting side which at any given time contains the entire portion of the track currently being transmitted which has already been transmitted; and,
as each said listener connects with said streaming means, sequentially transmitting the contents of said track buffer from the beginning of the broadcast track that it contains, thus ensuring that said listener receives the entire portion of said broadcast track that has already been transmitted.

41. The method of claim 1 wherein said which streaming means maintains a track buffer on the transmitting side which at any given time contains the entire portion of the track currently being transmitted which has already been transmitted, and, as each said listener connects with said streaming means, sequentially transmits the contents of said track buffer from the beginning of the broadcast track that it contains, thus ensuring that said listener receives the entire portion of said broadcast track that has already been transmitted.

42. The method of claim 14 wherein said which streaming means maintains a track buffer on the transmitting side which at any given time contains the entire portion of the track currently being transmitted which has already been transmitted, and, as each said listener connects with said streaming means, sequentially transmits the contents of said track buffer from the beginning of the broadcast track that it contains, thus ensuring that said listener receives the entire portion of said broadcast track that has already been transmitted.

43. The method of claim 14, further providing a portable device that utilizes a second acquisition buffer for holding segments of said stream of content which may be copied from time to time from the receiving acquisition buffer.

44. The method of claim 43 wherein said segments of said stream of content held in said second acquisition buffer are in encrypted format.

45. The method of claim 43 further providing on said portable device a user interface from which a user may select a segment of content for download.

46. The method of claim 43 wherein said copying of content from said receiving acquisition buffer to the second acquisition buffer may overwrite the oldest content contained in said second acquisition buffer so that, at any given time, said second acquisition buffer contains the most recently received content.

47. The method of claim 43 wherein the playing of any expired segment of content is prevented.

48. The method of claim 43 wherein the playing of an expired stream of content from the beginning of said expired stream is required in order to play any track contained in said expired stream.

49. The method of claim 43 wherein the playing of an expired segment of content more than a predetermined number of times within a predetermined interval of time is prevented.

50. The method of claim 43 wherein a predetermined delay is required between successive playings of an expired segment of content.

51. The method of claim 43 wherein the playing of any expired segment of content in its entirety is prevented.

52. The method of claim 43 wherein the playing of any said expired segment of content is interrupted from time to time by one or more of the following:
sound extraneous to said content
silence
requiring the user to take some manual action to continue playing

53. The method of claim 43 wherein the playing of any said expired segment of content is partly or wholly overlaid with sound extraneous to said content.
